(19) United States
(12) Patent Application Publication
(10) Pub. No.: US 2021/0099040 A1
(43) Pub. Date: Apr. 1, 2021

(54) STATOR AND MOTOR

(71) Applicant: Nidec Corporation, Kyoto (JP)

(72) Inventors: Yukinobu SHIRAISHI, Kyoto (JP); Takashi UCHINO, Kyoto (JP)

(21) Appl. No.: 17/015,966

(22) Filed: Sep. 9, 2020

(30) Foreign Application Priority Data
Sep. 26, 2019 (JP) 2019-176164

(51) Int. Cl. H02K 3/32; H02K 1/14; H02K 21/22

(52) U.S. Cl. CPC H02K 3/325; H02K 21/22; H02K 1/146

(57) ABSTRACT

An insulator includes an upper side surface cover portion and a lower side surface cover portion. The upper side surface cover portion covers the upper side surfaces of teeth. The lower side surface cover portion covers the lower side surfaces of the teeth. The upper side surface cover portion includes an upper umbrella cover portion and an upper thin portion. The upper umbrella cover portion covers upper portions of radially inner surfaces of umbrella portions. The upper thin portion protrudes downward from a lower end of the upper umbrella cover portion in the axial direction and is thinner than the upper umbrella cover portion in a radial direction. The lower umbrella cover portion covers lower portions of the radially inner surfaces of the umbrella portions. The lower thin portion protrudes upward from an upper end of the lower umbrella cover portion in the axial direction and is thinner than the lower umbrella cover portion in the radial direction. The upper thin portion and the lower thin portion overlap each other in the radial direction, and in each of the umbrella portions, a circumferential end of at least one of the upper thin portion and the lower thin portion is located closer to an extension portion than circumferential ends of the upper umbrella cover portion and the lower umbrella cover portion.

### CROSS REFERENCE TO RELATED APPLICATION

The present application claims priority under 35 U.S.C. § 119 to Japanese Application No. 2019-176164 filed on Sep. 26, 2019, the entire contents of which are hereby incorporated herein by reference.

### 1. FIELD OF THE INVENTION

The present disclosure relates to a stator and a motor.

### 2. BACKGROUND

A conventional stator includes, for example, a stator core and an insulator. The stator core is formed by arranging a plurality of cores (teeth) at regular intervals in the circumferential direction. The insulator is divided into two in the axial direction, and one of them covers the upper surface of the stator core. The other covers the lower surface of the stator core.

However, in the conventional stator, a gap is formed between the lower end of the axially upper insulator and the upper end of the axially lower insulator. Therefore, when a conductive wire is wound around the core, the conductive wire and the stator core may come into contact with each other, which may deteriorate insulation property.

### SUMMARY

A stator according to an example embodiment of the present disclosure includes a stator core, an insulator, and a coil. The stator core includes a core back and a plurality of teeth. The core back is annular and surrounds a central axis that extends vertically. The teeth extend radially outward from the core back and are arranged in the circumferential direction. The insulator covers the stator core. The coil is defined by a conductive wire wound around the teeth through the insulator. Each of the teeth includes an extension portion and an umbrella portion. The extension portion extends radially outward from a radially outer surface of the core back. The umbrella portion extends to each side in the circumferential direction from a radially outer end of the extension portion. The insulator includes an upper side surface cover portion and a lower side surface cover portion. The upper side surface cover portion covers the upper side surfaces of the teeth. The lower side surface cover portion covers the lower side surfaces of the teeth. The upper side surface cover portion includes an upper umbrella cover portion and an upper thin portion. The upper umbrella cover portion covers upper portions of radially inner surfaces of the umbrella portions. The upper thin portion protrudes downward from a lower end of the upper umbrella cover portion in the axial direction and is thinner than the upper umbrella cover portion in a radial direction. The lower umbrella cover portion covers lower portions of the radially inner surfaces of the umbrella portions. The lower thin portion protrudes upward from an upper end of the lower umbrella cover portion in the axial direction and is thinner than the lower umbrella cover portion in the radial direction. The upper thin portion and the lower thin portion overlap each other in the radial direction, and in each of the umbrella portions, a circumferential end of at least one of the upper thin portion and the lower thin portion is located closer to the extension portion than circumferential ends of the upper umbrella cover portion and the lower umbrella cover portion.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a longitudinal sectional perspective view of a motor according to an example embodiment of the present disclosure.

FIG. 2 is a perspective view of a stator according to an example embodiment of the present disclosure.

FIG. 3 is a perspective view showing a portion of a stator according to an example embodiment of the present disclosure.

FIG. 4 is a top sectional view showing a portion of a stator according to an example embodiment of the present disclosure.

FIG. 5 is an exploded perspective view of a stator core and an insulator according to an example embodiment of the present disclosure.

FIG. 6 is an exploded perspective view of a stator core and an insulator according to an example embodiment of the present disclosure.

FIG. 7 is a top view showing a portion of a stator according to an example embodiment of the present disclosure.

FIG. 8 is a sectional view taken along a line A-A in FIG. 7.

FIG. 9 is a top sectional perspective view showing a portion of a stator according to an example embodiment of the present disclosure.

### DETAILED DESCRIPTION

Hereinafter, example embodiments of the present disclosure will be described in detail with reference to the drawings. In the present specification, a direction parallel to the central axis of a motor is referred to by the term “axial direction”, “axial”, or “axially”, a direction perpendicular to the central axis of the motor is referred to by the term “radial direction”, “radial”, or “radially”, and a direction along the arc about the central axis of the motor is referred to by the term “circumferential direction”, “circumferential”, or “circumferentially”. In the present disclosure, the shape or the positional relationship of each component will be described on the basis of the axial direction being the vertical direction and a side where a terminal pin is disposed with respect to a stator core being the lower side. The above definition of the vertical direction is made simply for the sake of convenience of description, and does not limit the actual positional relation and direction.

In the present disclosure, a “parallel direction” includes a substantially parallel direction. In the present disclosure, a “perpendicular direction” includes a substantially perpendicular direction.

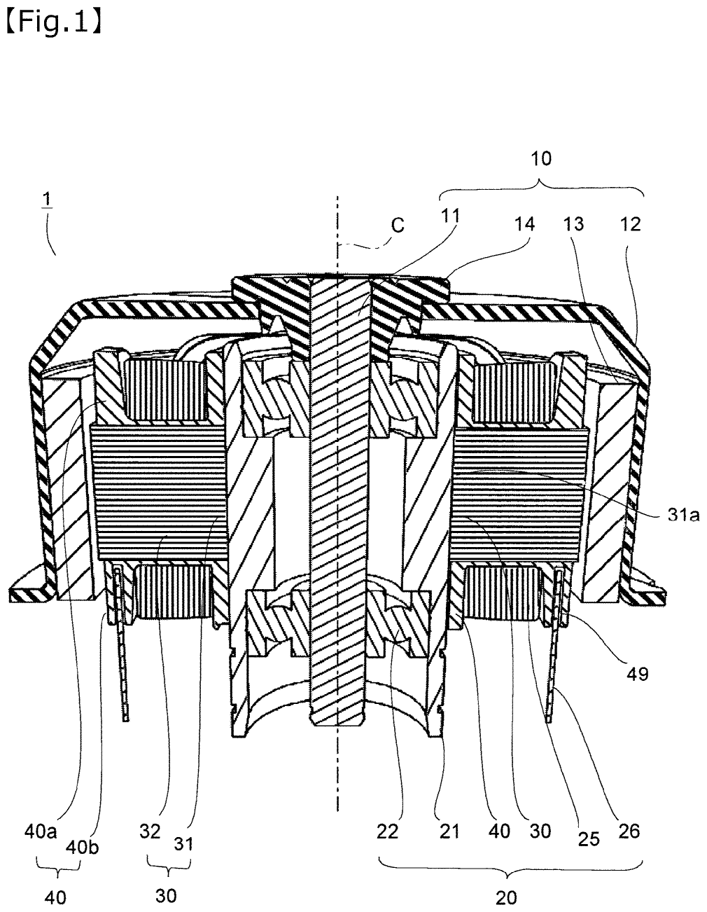

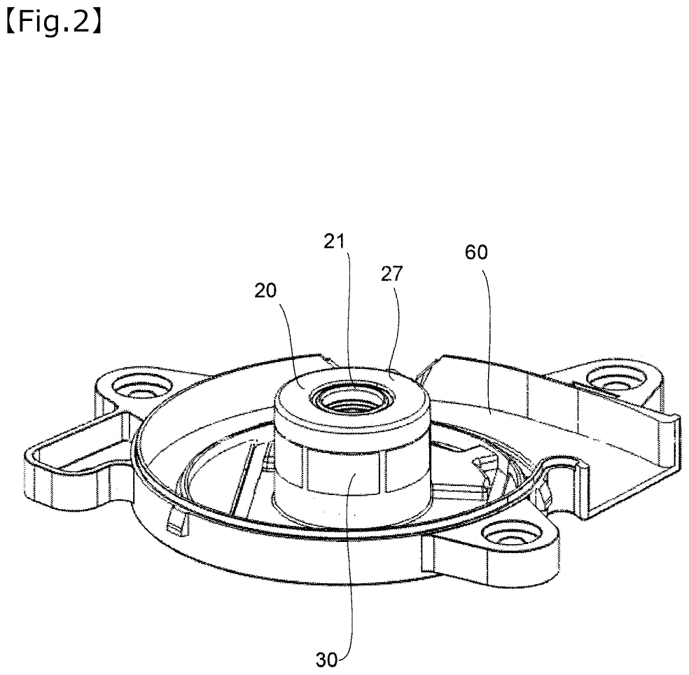

A motor according to an example embodiment of the present disclosure will be described. FIG. 1 is a longitudinal sectional perspective view of a motor 1 according to the present disclosure, and FIG. 2 is a perspective view of a stator 20. In FIG. 1, a mold part 27 is not illustrated.

The motor 1 includes a rotor 10 and a stator 20 which are installed in a housing 60. The rotor 10 is rotatable about a central axis C extending in the vertical direction. The stator 20 drives and rotates the rotor 10.

The rotor 10 includes a shaft 11, a rotor holder 12, a rotor magnet 13, and a joint part 14. The shaft 11 is a columnar metal member that rotates about the central axis C extending in the vertical direction.

The rotor holder 12 is a bottomed cylindrical member, and is connected to an upper end of the shaft 11 via the joint part 14. The rotor magnet 13 is fixed to the inner surface of the rotor holder 12, and is disposed to face the radially outer side of the stator 20. The rotor magnet 13 has N poles and S poles which are alternately arranged in the circumferential direction. That is, the rotor 10 is supported to be rotatable about the central axis C, and has a magnetic pole surface that faces the radially outer side of the stator 20.

The stator 20 includes a bearing housing 21, a bearing 22, a stator core 30, an insulator 40, a coil 25, a terminal pin 26, and a mold part 27.

The bearing housing 21 is formed in a cylindrical shape and holds two bearings 22 inside. The bearings 22 rotatably support the shaft 11. A ball bearing is used for the bearings 22, for example. Note that a sleeve bearing may be used as the bearings 22.

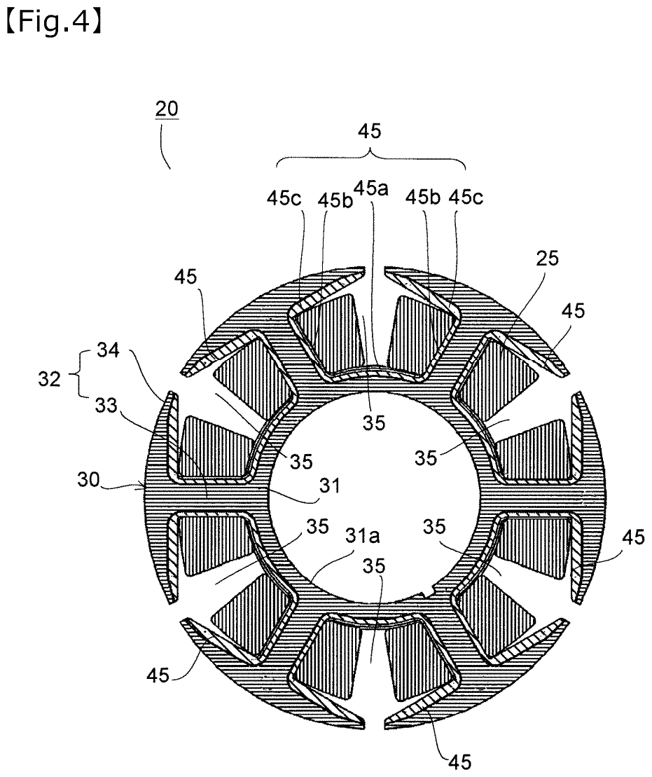

The stator core 30 surrounds the central axis C and is disposed radially outside the bearing housing 21. The stator core 30 is formed by laminating a plurality of annular laminated steel plates in the axial direction. The stator core 30 has a core back 31 and teeth 32 (see FIG. 4). The core back 31 has an annular shape having an insertion hole 31a on the central axis C. The bearing housing 21 is inserted into the insertion hole 31a. A plurality of teeth 32 is disposed in the circumferential direction so as to extend radially outward from the radially outer surface of the core back 31. That is, the stator core 30 has the annular core back 31 that surrounds the central axis C extending in the vertical direction and a plurality of teeth 32 that extends radially outward from the core back 31 and is arranged in the circumferential direction.

The insulator 40 is made of an insulating resin molded product and covers a part of the stator core 30. The insulator 40 has an upper insulator 40a and a lower insulator 40b. The upper insulator 40a covers the upper surface of the stator core 30 in the axial direction. The lower insulator 40b covers the lower surface of the stator core 30 in the axial direction. The detailed configurations of the stator core 30 and the insulator 40 will be described later.

The coil 25 is formed by winding a conductive wire (not shown) around each tooth 32 via the insulator 40. The stator core 30 and the conductive wire are insulated from each other by the insulator 40.

The terminal pin 26 extends in the axial direction and is connected to the conductive wire. The upper end of the terminal pin 26 is inserted into a holding hole 49 formed in the lower insulator 40b and fixed to the lower insulator 40b. The lower end of the terminal pin 26 is inserted into a through hole (not shown) formed in a circuit board (not shown) and soldered to the circuit board.

The mold part 27 covers the stator core 30, the insulator 40, the coil 25, the terminal pin 26, and the surface of the circuit board (not shown) (see FIG. 2). The mold part 27 is formed by placing a mold surrounding the radially outer side of the stator 20 with the stator 20 fixed to the housing 60, and filling the mold with molten mold resin. As the mold resin, a thermoplastic resin material such as polyamide is used, for example. Due to the mold part 27 being formed, the stator 20 can be protected from water and dust. When the molding resin is filled, the bearing housing 21 is inserted into the insertion hole 31a, and the radially inner surface of the stator core 30 is not covered with the mold part 27.

When a drive current is applied to the coil 25, magnetic flux is generated in the teeth 32. Accordingly, circumferential torque is generated between the teeth 32 and the rotor magnet 13. Thus, the rotor 10 rotates about the central axis C with respect to the stator 20.

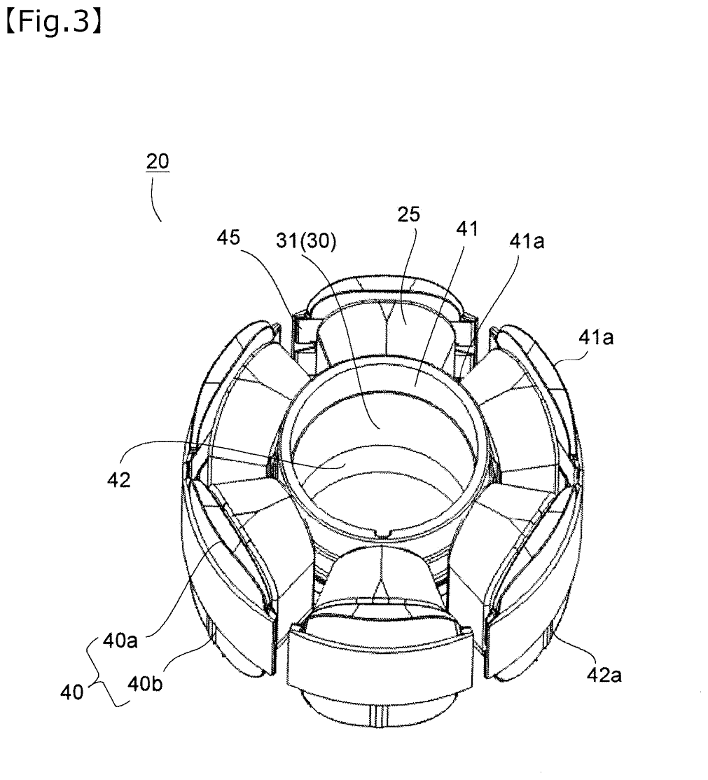

FIGS. 3 and 4 are respectively a perspective view and a top sectional view of the stator 20. The bearing housing 21, the bearings 22, the terminal pin 26, and the mold part 27 are not illustrated in FIGS. 3 and 4.

Each of the teeth 32 has an extension part 33 and an umbrella part 34. The extension part 33 extends radially outward from the radially outer surface of the core back 31. The umbrella part 34 extends to each side from the radially outer end of the extension part 33 in the circumferential direction. The umbrella part 34 is formed symmetrical in the circumferential direction with respect to the centerline of the extension part 33 perpendicular to the central axis C.

The stator core 30 has slots 35 formed in the same number as the teeth 32 in the circumferential direction. Each slot 35 is defined by a space surrounded by the radially outer surface of the core back 31, the circumferentially outer surface of the extension part 33, and the radially inner surface of the umbrella part 34.

The insulator 40 has an upper surface cover part 41, a lower surface cover part 42, and a side surface cover part 45. The upper surface cover part 41 is constituted by the upper insulator 40a. The upper surface cover part 41 covers the upper surface of the core back 31, the upper surfaces of the extension parts 33, and the upper surfaces of the umbrella parts 34. Further, the upper surface cover part 41 has an upper support part 41a. The upper support part 41a is disposed above the core back 31 and the umbrella parts 34 in the axial direction, and protrudes upward from the upper surface in the axial direction.

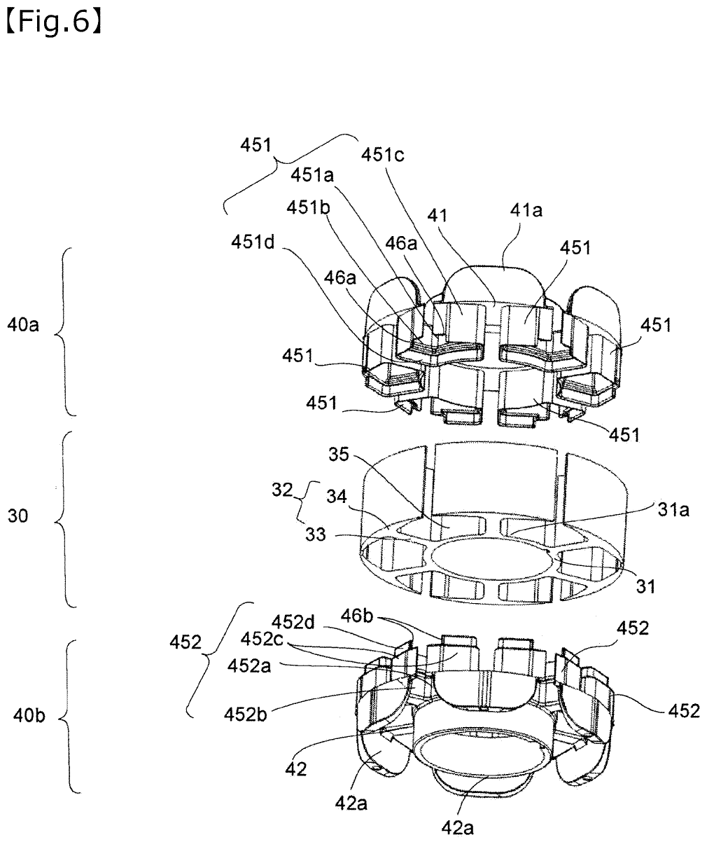

The lower surface cover part 42 is constituted by the lower insulator 40b. The lower surface cover part 42 covers the lower surface of the core back 31, the lower surfaces of the extension parts 33, and the lower surfaces of the umbrella parts 34. Further, the lower surface cover part 42 has a lower support part 42a (see FIG. 6). The lower support part 42a is disposed below the core back 31 and the umbrella parts 34 in the axial direction, and protrudes downward from the lower surface in the axial direction. The upper support part 41a and the lower support part 42a support the conductive wire wound around the teeth 32 in the radial direction, thereby being capable of preventing collapse of the wound conductive wire.

The side surface cover part 45 is constituted by the upper insulator 40a and the lower insulator 40b. The side surface cover parts 45 are arranged in the same number as the slots 35 in the circumferential direction. Each side surface cover part 45 surrounds the corresponding slot 35 and extends in the axial direction. The side surface cover part 45 is formed in a C shape in a top view. The side surface cover part 45 is open in a region that radially faces a space formed between the ends of the adjacent umbrella parts 34 in the circumferential direction.

Specifically, the side surface cover part 45 has a core cover part 45a, an extension cover part 45b, and an umbrella cover part 45c. The core cover part 45a covers the radially outer surface of the core back 31. The extension cover part 45b covers the circumferentially outer surface of the extension part 33. The umbrella cover part 45c covers the radially inner surface of the umbrella part 34.

The side surface cover part 45 is formed to be thin in the cross section perpendicular to the central axis C, whereby the space of the slot 35 surrounded by the side surface cover part 45 is increased. Accordingly, the number of turns of the conductive wire that can be wound into the slot 35 can be increased. Therefore, the driving efficiency of the motor 1 can be enhanced.

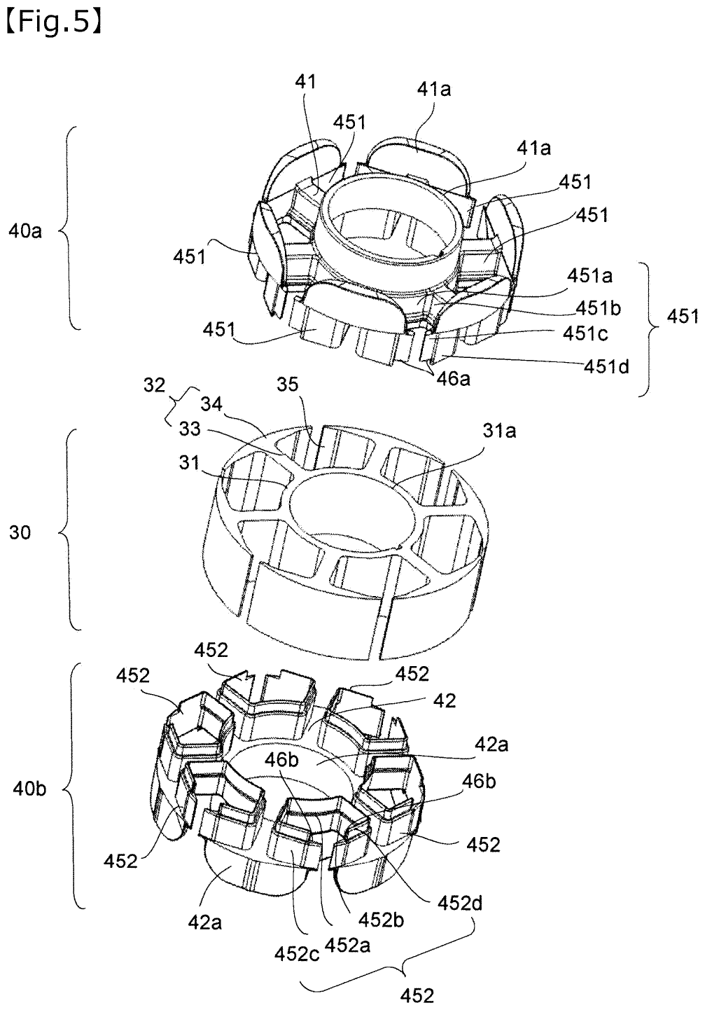

FIGS. 5 and 6 are exploded perspective views of the stator core 30 and the insulator 40. FIG. 5 is a view of the stator core 30 and the insulator 40 as viewed from top in the axial direction, and FIG. 6 is a view of the stator core 30 and the insulator 40 as viewed from bottom in the axial direction.

The side surface cover part 45 is divided into an upper side surface cover part 451 and a lower side surface cover part 452 in the axial direction. The upper side surface cover part 451 has an upper end connected to the upper surface cover part 41 and covers the upper side surfaces of the teeth 32 and the core back 31. The lower side surface cover part 452 has a lower end connected to the lower surface cover part 42 and covers the lower side surfaces of the teeth 32 and the core back 31.

The upper side surface cover part 451 has an upper core cover part 451a, an upper extension cover part 451b, an upper umbrella cover part 451c, and an upper thin part 451d.

The lower side surface cover part 452 has a lower core cover part 452a, a lower extension cover part 452b, a lower umbrella cover part 452c, and a lower thin part 452d.

The upper core cover part 451a and the lower core cover part 452a overlap in the axial direction to form the core cover part 45a. The upper core cover part 451a covers the upper portion of the radially outer surface of the core back 31. The lower core cover part 452a covers the lower portion of the radially outer surface of the core back 31.

The upper extension cover part 451b and the lower extension cover part 452b overlap in the axial direction to form the extension cover part 45b. The upper extension cover part 451b covers the upper portion of the circumferentially outer surface of the extension part 33. The lower extension cover part 452b covers a lower portion of the circumferentially outer surface of the extension part 33.

The upper umbrella cover part 451c and the lower umbrella cover part 452c overlap each other in the axial direction to form the umbrella cover part 45c. The upper umbrella cover part 451c covers the upper portion of the radially inner surface of the umbrella part 34. The lower umbrella cover part 452c covers the lower portion of the radially inner surface of the umbrella part 34.

The upper umbrella cover part 451c and the lower umbrella cover part 452c are formed in a flat plate shape. Accordingly, the upper umbrella cover part 451c and the lower umbrella cover part 452c can be easily reduced in thickness.

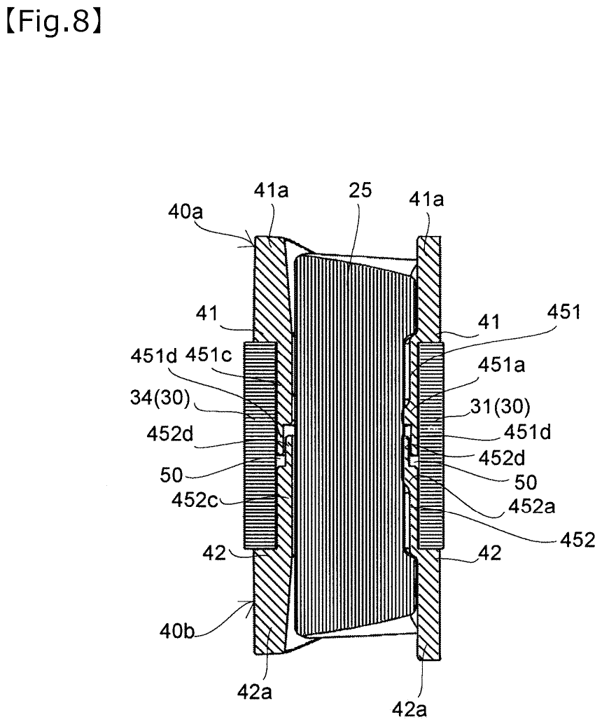

The upper thin part 451d protrudes downward from the lower ends of the upper core cover part 451a, the upper extension cover part 451b, and the upper umbrella cover part 451c in the axial direction. The lower thin part 452d protrudes upward from the upper ends of the lower core cover part 452a, the lower extension cover part 452b, and the lower umbrella cover part 452c in the axial direction. In this configuration, the upper thin part 451d does not overlap the lower thin part 452d in the axial direction, and is located between the lower thin part 452d and the stator core 30 in a plane perpendicular to the axial direction (see FIG. 8).

The upper thin part 451d is shorter than the upper core cover part 451a, the upper extension cover part 451b, and the upper umbrella cover part 451c in the axial direction. Similarly, the lower thin part 452d is shorter than the lower core cover part 452a, the lower extension cover part 452b, and the lower umbrella cover part 452c in the axial direction.

The upper thin part 451d is thinner than the upper core cover part 451a, the upper extension cover part 451b, and the upper umbrella cover part 451c. Specifically, the upper thin part 451d on the upper core cover part 451a is thinner than the upper core cover part 451a in the radial direction. The upper thin part 451d on the upper extension cover part 451b is thinner than the upper extension cover part 451b in the circumferential direction. The upper thin part 451d on the upper umbrella cover part 451c is thinner than the upper umbrella cover part 451c in the radial direction.

Similarly, the lower thin part 452d is thinner than the lower core cover part 452a, the lower extension cover part 452b, and the lower umbrella cover part 452c. Specifically, the lower thin part 452d on the lower core cover part 452a is thinner than the lower core cover part 452a in the radial direction. The lower thin part 452d on the lower extension cover part 452b is thinner than the lower extension cover part 452b in the circumferential direction. The lower thin part 452d on the lower umbrella cover part 452c is thinner than the lower umbrella cover part 452c in the radial direction.

The upper thin part 451d has an upper cutout 46a at the end in the circumferential direction. Thus, in each umbrella part 34, the circumferential end of the upper thin part 451d is located closer to the extension part 33 than the circumferential end of the upper umbrella cover part 451c. Similarly, the lower thin part 452d has a lower cutout 46b at the end in the circumferential direction. Thus, in each umbrella part 34, the circumferential end of the lower thin part 452d is located closer to the extension part 33 than the circumferential end of the lower umbrella cover part 452c.

If the cutouts 46a and 46b are not formed in the case of injection molding of the upper insulator 40a and the lower insulator 40b with the upper side surface cover part 451 and the lower side surface cover part 452 being reduced in thickness, resin is hard to wrap around the circumferential ends of the upper thin part 451d and the lower thin part 452d. In the present example embodiment, the upper thin part 451d and the lower thin part 452d are provided with cutouts 46a and 46b at their circumferential ends. As a result, the resin wraps around the ends of the upper thin part 451d and the lower thin part 452d in the circumferential direction, whereby molding defect of the upper insulator 40a and the lower insulator 40b can be reduced. Therefore, the upper side surface cover part 451 and the lower side surface cover part 452 can be molded with reduced thickness, so that the space of the slot 35 surrounded by the upper side surface cover part 451 and the lower side surface cover part 452 is increased. Accordingly, the number of turns of the conductive wire that can be wound into the slot 35 can be increased. Thus, the driving efficiency of the motor 1 can be enhanced.

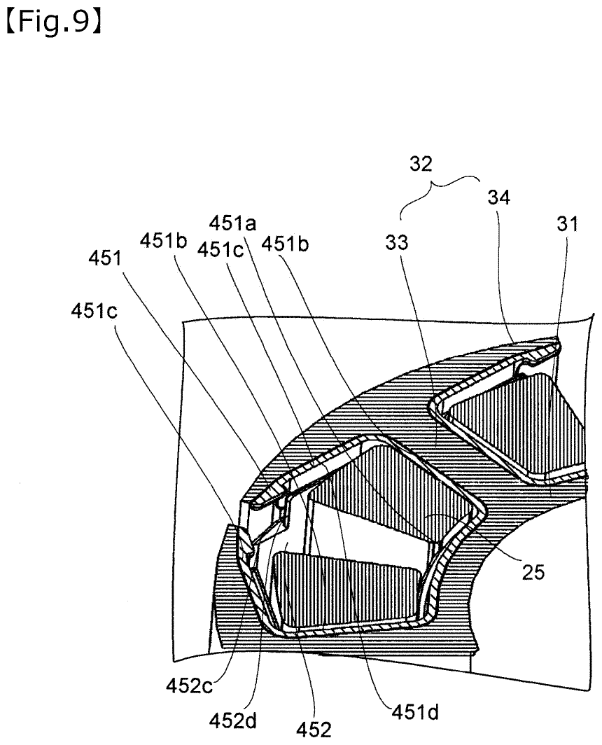

The circumferential end of the upper thin part 451d extends in a direction substantially perpendicular to the axially lower surface of the upper umbrella cover part 451c. Further, the circumferential end of the lower thin part 452d extends in a direction substantially perpendicular to the axially upper surface of the lower umbrella cover part 452c (see FIG. 9). Thus, the resin wraps around the circumferential ends of the upper thin part 451d and the lower thin part 452d more easily. Accordingly, the upper side surface cover part 451 and the lower side surface cover part 452 can be molded with further reduced thickness.

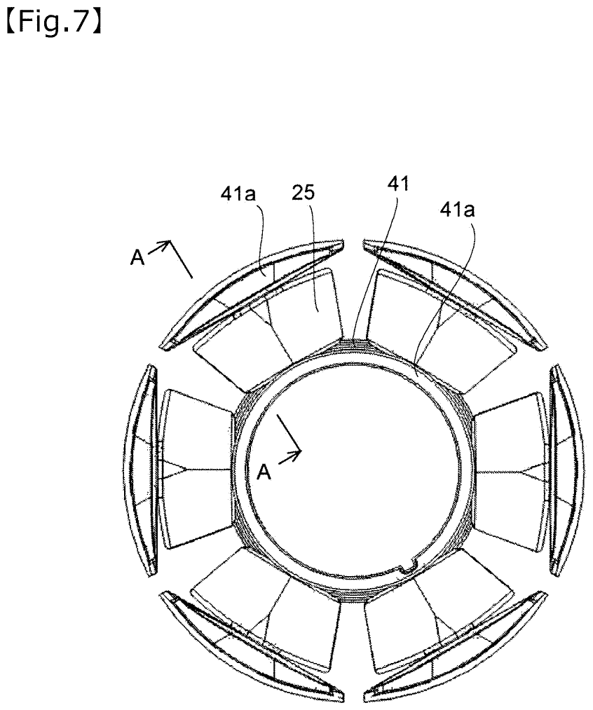

FIG. 7 is a top view of the stator 20, and FIG. 8 is a sectional view taken along a line A-A in FIG. 7. FIG. 9 is a top sectional perspective view of the stator. Note that the mold part 27 is not illustrated in FIGS. 7 to 9. When the lower insulator 40b is attached to the stator core 30, a groove 50 is formed between the side surfaces of the lower thin parts 452d and the side surface of the stator core 30. When the upper insulator 40a is attached to the stator core 30, the upper thin parts 451d are inserted into the groove 50.

At this time, the upper thin parts 451d on the upper core cover parts 451a and the lower thin parts 452d on the lower core cover parts 452a overlap in the radial direction. Further, the upper thin parts 451d on the upper umbrella cover parts 451c and the lower thin parts 452d on the lower umbrella cover parts 452c overlap in the radial direction. Similarly, the upper thin parts 451d on the upper extension cover parts 451b and the lower thin parts 452d on the lower extension cover parts 452b overlap in the circumferential direction.

Therefore, when the conductive wire (not shown) is wound around each tooth 32, the upper thin part 451d and the lower thin part 452d are present between the conductive wire and the stator core 30. Therefore, contact between the conductive wire and the stator core 30 is prevented, which can improve the insulation property.

The conductive wire is not wound to a position that radially faces the cutouts 46a and 46b where the stator core 30 is exposed (see FIG. 9). That is, the circumferential ends of the upper thin part 451d and the lower thin part 452d are located farther from the extension part 33 than the circumferential end of the coil 25. Therefore, the insulation property can be further improved.

The mold part (not shown) that covers the stator core 30, the insulator 40, and the coil 25 covers the radially inner surfaces of the umbrella parts 34 that are exposed on the outside of the upper thin parts 451d and the lower thin parts 452d in the circumferential direction. Thus, the insulation property can be further improved.

The upper insulator 40a is axially positioned with the upper surface cover part 41 in contact with the upper surface of the stator core 30. At this time, the upper thin parts 451d do not contact the lower thin parts 452d in the radial direction. Further, the lower ends of the upper thin parts 451d are located axially above and do not contact the upper ends of the lower core cover parts 452a, the lower extension cover parts 452b, and the lower umbrella cover parts 452c. Similarly, the upper ends of the lower thin parts 452d are located axially below and do not contact the lower ends of the upper core cover parts 451a, the upper extension cover parts 451b, and the upper umbrella cover parts 451c.

Thus, when the upper insulator 40a and the lower insulator 40b are mounted on the stator core 30, the upper thin parts 451d and the lower thin parts 452d can be prevented from being damaged.

The above example embodiment is merely an example of the present disclosure. The configuration of the example embodiment may be appropriately modified without departing from the technical idea of the present disclosure. The example embodiment may be implemented in combination as far as possible.

In the present example embodiment, the upper cutout 46a and the lower cutout 46b are provided at the circumferential ends of both the upper thin part 451d and the lower thin part 452d. However, only one of the upper cutout 46a and the lower cutout 46b may be provided.

The present disclosure can be used for a stator and a motor mounted in, for example, OA equipment, medical equipment, household electric appliances, transportation equipment, and the like.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A stator comprising:
a stator core including a core back that is annular and that surrounds a central axis extending in a vertical direction, and a plurality of teeth that extends radially outward from the core back and is arranged in a circumferential direction;
an insulator that covers the stator core; and
a coil including a conductive wire wound around the teeth via the insulator; wherein
each of the teeth includes:
an extension portion that extends radially outward from a radially outer surface of the core back; and
an umbrella portion that extends to each side in the circumferential direction from a radially outer end of the extension portion;
the insulator includes:
an upper side surface cover portion that covers upper side surfaces of the teeth; and
a lower side surface cover portion that covers lower side surfaces of the teeth;
the upper side surface cover portion includes an upper umbrella cover portion that covers upper portions of radially inner surfaces of the umbrella portions, and an upper thin portion that protrudes downward from a lower end of the upper umbrella cover portion in the axial direction and that is thinner than the upper umbrella cover portion in a radial direction;
the lower side surface cover portion includes a lower umbrella cover portion that covers lower portions of the radially inner surfaces of the umbrella portions, and a lower thin portion that protrudes upward from an upper end of the lower umbrella cover portion in the axial direction and that is thinner than the lower umbrella cover portion in the radial direction;
the upper thin portion and the lower thin portion overlap each other in the radial direction; and
in each of the umbrella portions, a circumferential end of at least one of the upper thin portion and the lower thin portion is located closer to the extension portion than circumferential ends of the upper umbrella cover portion and the lower umbrella cover portion.

2. The stator according to claim 1, wherein the circumferential end of the upper thin portion or the lower thin portion is located farther from the extension portion than a circumferential end of the coil.

3. The stator according to claim 1, wherein the upper umbrella cover portion or the lower umbrella cover portion has a flat plate shape.

4. The stator according to claim 1, wherein the circumferential end of the upper thin portion or the lower thin portion extends in a direction perpendicular or substantially perpendicular to an axially lower surface of the upper umbrella cover portion or an axially upper surface of the lower umbrella cover part.

5. The stator according to claim 1, further comprising a mold portion that covers the stator core, the insulator, and the coil, wherein
the circumferential ends of the upper thin portion and the lower thin portion are located closer to the extension portion than the circumferential ends of the upper umbrella cover portion and the lower umbrella cover portion; and
the mold portion covers radially inner surfaces of the umbrella portions exposed outside of the upper thin portion and the lower thin portion in the circumferential direction.

6. The stator according to claim 1, wherein
a lower end of the upper thin portion is located above an upper end of the lower umbrella cover portion in the axial direction; and
an upper end of the lower thin portion is located below a lower end of the upper umbrella cover portion.

7. A motor comprising:
the stator according to claim 1; and
a rotor that is rotatably supported about the central axis and that includes a magnetic pole surface that faces the stator radially outward.
